(19) United States
(12) Patent Application Publication
(10) Pub. No.: US 2008/0079750 A1
(43) Pub. Date: Apr. 3, 2008

(54) PERCEPTUALLY ADAPTIVE GRAPHICAL USER INTERFACE

(76) Inventor: Vidya Setlur, Cupertino, CA (US)

Correspondence Address: PERMAN & GREEN, 425 POST ROAD, FAIRFIELD, CT, 06824, US

(21) Appl. No.: 11/537,137

(22) Filed: Sep. 29, 2006

(51) Int. Cl. G09G 5/02

(52) U.S. Cl. 345/593

(57) ABSTRACT

An apparatus including a display and a processor connected to the display, the processor configured to automatically modify an input user interface according to a perceptual optimization function and to cause an output user interface to be presented on the display.

### BACKGROUND

1. Field

The present embodiments relate to user interfaces and, more particularly, to perceptual user interfaces.

2. Brief Description of Related Developments

Perceptual user interfaces are defined from human perspective of how different sensory experiences (e.g. vision, hearing, speech and touch) affect how computational machines can present information to the user. Perceptual user interfaces can interact with users via various sensory channels more effectively than conventional interfaces. The perception of resolution and readability is problematic with conventional user interfaces and draws on a range of disciplines from perceptual psychology to human vision.

Colors and fonts are used in user interfaces and applications to represent information, focus a user's attention on a particular detail or enhance display aesthetics. Although there may be general design guidelines regarding the use of colors and fonts, these guidelines do not account for the factors included in or derived from the range of disciplines, such as perceptual psychology and human vision, that would enable the development of user interfaces in accordance with these disciplines. Application developers misinterpret or ignore the guidelines and as a result, colors and fonts are often selected without considering the readability of the color/font combinations. For example, with internet or web interfaces the choice of font size and color may vary based on the surrounding background color, resolution and the intent of the information itself (e.g. a formal document, an invitation, an interface for children, etc). In addition, interfaces and applications such as web browsers and web pages are increasingly being designed to include media such as animated or still images that can be dynamically updated by the browser which further complicates the color and font decisions as the content of the images must also be accounted for in the interface design.

Layouts with minimal feature variation are used in conventional applications and user interfaces to the point where the interfaces are indistinguishable. These indistinguishable color schemes and layouts do not provide a user with an exciting experience while using the interface or applications. Colors can rapidly change the mood the user, alter the user's opinion or get the user excited.

It would be advantageous to have user interfaces and applications that employ color schemes that distinguish the user interface from conventional user interfaces while incorporating perception effects to enhance the user's experience and to cater to the visual needs of the user and the user's tasks. It would also be advantageous to have user interfaces and applications that employ principles from human vision, perception and context to determine the optimal representation of graphical user interfaces rather than use authoring tools to change the user interface every time content such as media is added/modified/removed, or when the display resolution changes.

### SUMMARY

In one embodiment, an apparatus is provided. The apparatus includes a display and a processor connected to the display, the processor configured to automatically modify an input user interface according to a perceptual optimization function and to cause an output user interface to be presented on the display.

In another embodiment, a method is provided. The method includes determining a dominant color of an input user interface, formulating a perceptual optimization function and automatically modifying the input user interface according to the perceptual optimization function and causing an output user interface to be presented on the display.

In accordance with one embodiment, a computer program product is provided. The computer program product includes a computer useable medium having computer readable code means embodied therein for causing a computer to automatically modify a user interface. The computer readable code means in the computer program product includes computer readable code means for causing a computer to automatically modify a user interface according to a perceptual optimization function and to cause an output user interface to be presented on a display.

### BRIEF DESCRIPTION OF THE DRAWINGS

The foregoing aspects and other features of the present embodiments are explained in the following description, taken in connection with the accompanying drawings, wherein:

FIG. 1 shows a schematic illustration of a communications system, as an example, of an environment in which aspects of an embodiment may be applied;

FIG. 2 illustrates a device incorporating aspects of an embodiment;

FIG. 3 illustrates another device incorporating aspects of an embodiment;

FIG. 4 shows a schematic block diagram of an interface optimization in accordance with an embodiment;

FIGS. 5A-5C show color schemes in accordance with an embodiment;

FIGS. 6A-6E illustrates color schemes in accordance with an embodiment;

FIG. 7 illustrates thresholding in accordance with an embodiment;

FIGS. 8A-8B show edge detection in accordance with an embodiment;

FIGS. 9A-9B show filtering in accordance with an embodiment;

FIG. 10 illustrates a schematic view of filtering in accordance with an embodiment;

FIGS. 11A-11B illustrate histograms in accordance with an exemplary embodiment;

FIGS. 11C-11D show histogram equalization in accordance with an exemplary embodiment;

FIGS. 12A-12B show user interfaces in accordance with an embodiment;

FIGS. 13A-13B show user interfaces in accordance with an embodiment;

FIG. 14 illustrates a flow diagram of a method in accordance with an embodiment;

FIG. 15 illustrates a user interface in accordance with an embodiment;

FIG. 16 illustrates user interfaces in accordance with an embodiment; and

FIG. 17 illustrates a block diagram of one embodiment of an apparatus incorporating features that may be used to practice aspects of an embodiment.

### DETAILED DESCRIPTION OF THE EXEMPLARY EMBODIMENT(S)

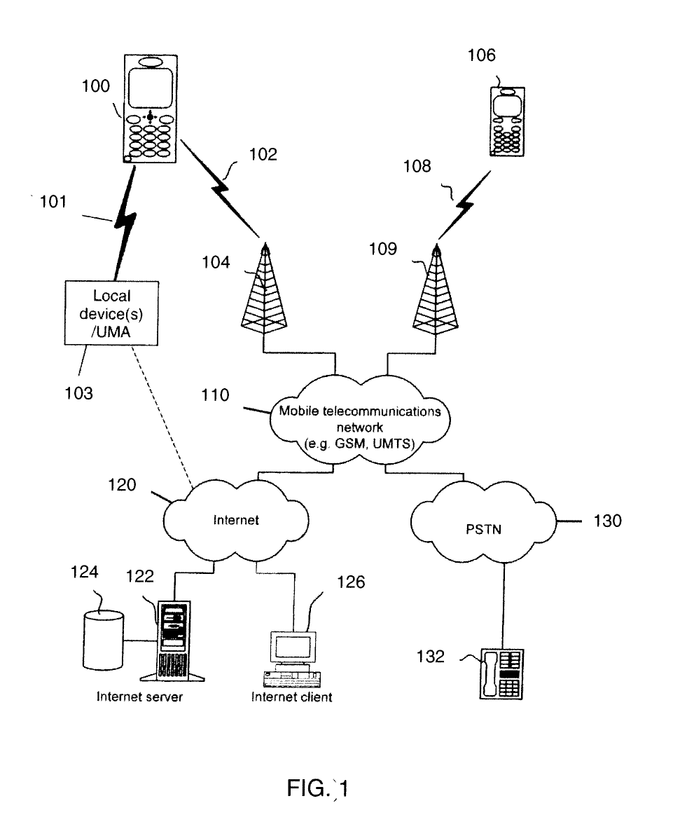

FIG. 1 is a schematic illustration of a cellular telecommunications system, as an example, of an environment in which a communications device 100 incorporating features of an exemplary embodiment may be applied. Although aspects of the invention will be described with reference to the embodiments shown in the drawings and described below, it should be understood that these aspects could be embodied in many alternate forms of embodiments. In addition, any suitable size, shape or type of elements or materials could be used.

The use of color on the displays of electronic devices is becoming increasingly important as the displays become more sophisticated. Color displays may have a lower resolution than black and white displays because three phosphors are required to create the different colors on the display. Edges created by color alone are difficult to resolve as some colors may blur together or be similar shades. Deficiencies in color vision such as with for example, color blindness, are often amplified because of the sharply peaked spectrum of red color.

The use of color in electronic displays often results in a low contrast ratio, especially in text. Colors are generally overused and can clutter up the screen. Different colors such as highly saturated colors at opposite ends of the color spectrum sometimes appear in different depth planes that may contradict the intended meaning of the color (e.g. red for “hazard” or “stop”, green for “go”, etc.). In addition, color perception may be affected by a surrounding color contrast and color adaptation effects such as for example, a blue background induces a change toward yellow.

The user interfaces and applications disclosed herein for use on electronic displays may employ color schemes that distinguish the user interface from conventional user interfaces while incorporating color perception effects to enhance the user's experience and to cater to the visual needs of the user and the user's tasks. These user interfaces and applications may also employ principles from human vision, perception and context to determine the optimal representation of graphical user interfaces rather than use authoring tools to change the user interface every time content such as media is added/modified/removed, or when the display resolution changes. The interfaces and applications may allow a user to interact with or through any suitable device as described below.

In the communication system of FIG. 1, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 100 and other devices, such as another mobile terminal 106, a stationary telephone 132, or an internet server 122. It is to be noted that for different embodiments of the mobile terminal 100 and in different situations, different ones of the telecommunications services referred to above may or may not be available. The aspects of the invention are not limited to any particular set of services in this respect.

The mobile terminals 100, 106 may be connected to a mobile telecommunications network 110 through radio frequency (RF) links 102, 108 via base stations 104, 109. The mobile telecommunications network 110 may be in compliance with any commercially available mobile telecommunications standard such as GSM, UMTS, D-AMPS, CDMA2000, FOMA and TD-SCDMA.

The mobile telecommunications network 110 may be operatively connected to a wide area network 120, which may be the internet or a part thereof. An internet server 122 has data storage 124 and is connected to the wide area network 120, as is an internet client computer 126. The server 122 may host a www/hap server capable of serving www/hap content to the mobile terminal 100.

For example, a public switched telephone network (PSTN) 130 may be connected to the mobile telecommunications network 110 in a familiar manner. Various telephone terminals, including the stationary telephone 132, may be connected to the PSTN 130.

The mobile terminal 100 is also capable of communicating locally via a local link 101 to one or more local devices 103. The local link 101 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 103 can, for example, be various sensors that can communicate measurement values to the mobile terminal 100 over the local link 101. The above examples are not intended to be limiting, and any suitable type of link may be utilized. The local devices 103 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 100 may thus have multi-radio capability for connecting wirelessly using mobile communications network 110, WLAN or both. Communication with the mobile telecommunications network 110 may also be implemented using WiFi, WiMax, or any other suitable protocols, and such communication may utilize unlicensed portions of the radio spectrum (e.g. unlicensed mobile access (UMA)).

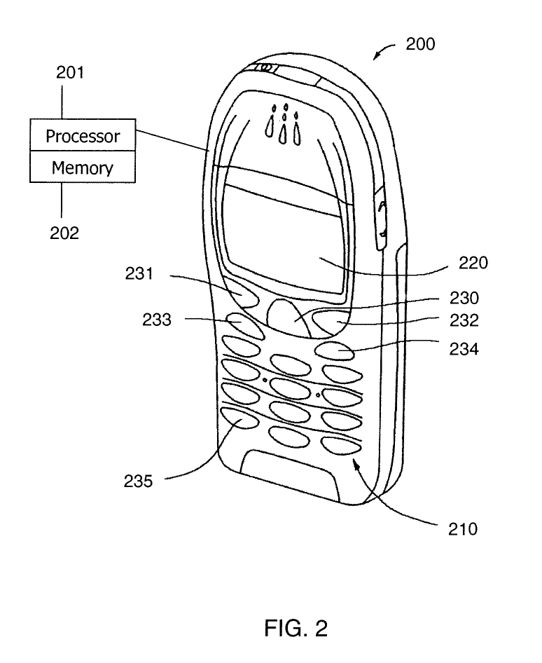

One embodiment 200 of a terminal 100 is illustrated in more detail in FIG. 2. The terminal or mobile communications device 200 may have a keypad 210 and a display 220. The keypad 210 may include any suitable user input devices such as, for example, a multi-function/scroll key 230, soft keys 231, 232, a call key 233 and end call key 234 and alphanumeric keys 235. The display 220 may be any suitable display, such as for example, a touch screen display or graphical user interface. The display may be integral to the device 200 or the display may be a peripheral display connected to the device 200. A pointing device, such as for example, a stylus, pen or simply the user's finger may be used with the display 220. In alternate embodiments any suitable pointing device may be used. In other alternate embodiments, the display may be a conventional display. The device 200 may also include other suitable features such as, for example, a camera, loud speaker, connectivity port or tactile feedback features. The mobile communications device may have a processor 201 connected to the display for processing user inputs and displaying information on the display 220. A memory 202 may be connected to the processor 201 for storing any suitable information and/or applications associated with the mobile communications device 200 such as phone book entries, calendar entries, etc.

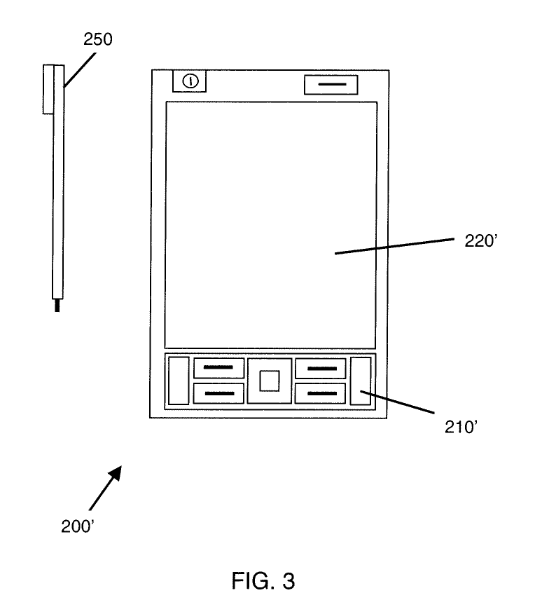

In another embodiment, the device 100, may be for example, a PDA style device 200′ illustrated in FIG. 3. The PDA 200′ may have a keypad 210′, a touch screen display 220′ and a pointing device 250 for use on the touch screen display 220′. In still other alternate embodiments, the device may be a personal communicator, a tablet computer, a laptop or desktop computer, a television or television set top box or any other suitable device capable of containing the display 220 and supported electronics such as the processor 201 and memory 202. The embodiments herein will be described with reference to the mobile communications device 100 for exemplary purposes only and it should be understood that the embodiments could be applied equally to any suitable device incorporating a display, processor, memory and supporting software or hardware.

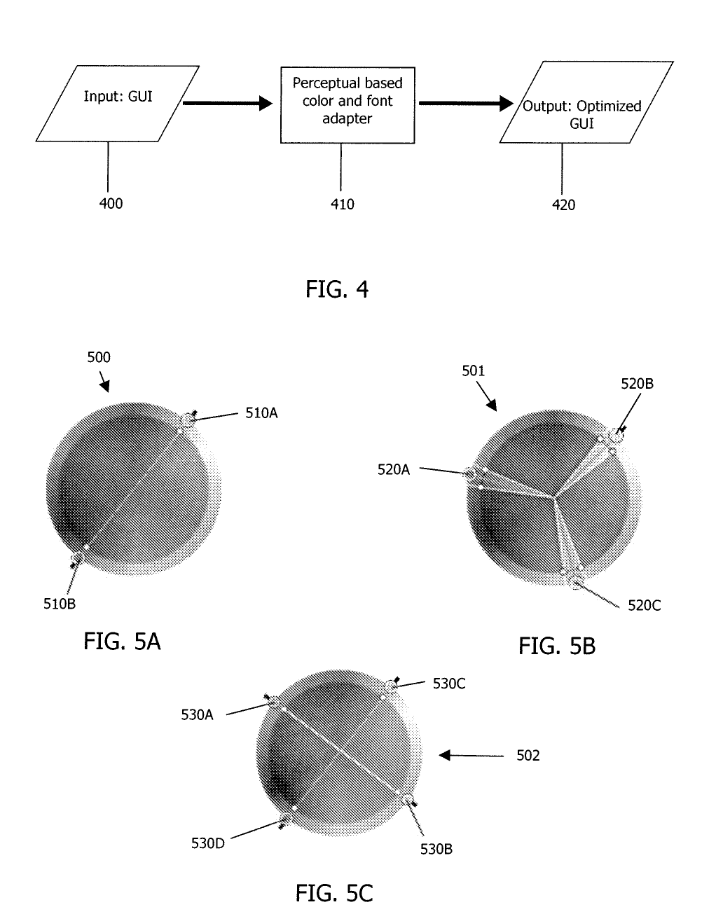

The disclosed embodiments relate to systems and methods for automatically optimizing the usage of color and font in user interfaces and applications on electronic devices, such as device 100 for better readability and aesthetics based on perceptual principles and image processing algorithms. A schematic diagram of a system in accordance with an embodiment is shown in FIG. 4. The system may include an input graphical user interface 400, a perceptual based color and font adapter 410 and an output graphical user interface 420. In alternate embodiments the system may have any suitable hardware and/or software components. The adapter may be any suitable adapter that may be software or hardware implemented. The adapter 410 may operate on the colors and font of the input user interface 400 via suitable algorithms to produce the enhanced output user interface 420 with improved readability and clarity.

The adapter, for example, may use any suitable algorithms to employ any suitable color theory to modify any suitable color scheme(s) and create enhanced user interfaces that are aesthetically pleasing and help the user perform certain tasks. Color relationships can be represented on, for example, a color wheel such as those shown in FIGS. 5A-5C. Although a color wheel is used herein for exemplary purposes only, any suitable representation of color relationships may be utilized. According to the color theory, harmonious color combinations use any suitable number of colors that are equally spaced apart from each other on the color wheel. Examples of harmonious color combinations include, but are not limited to, two colors 510A, 510B opposite each other on the color wheel, any three colors 520A, 520B, 520C equally spaced around the color wheel or any four colors 530A, 530B, 530C, 530D equally spaced around the color wheel. Where four colors are used, the colors 530A and 530B are one pair of colors opposite each other on the color wheel and the colors 530C and 530D are another pair of colors opposite each other on the color wheel. The harmonious color combinations referred to herein as color schemes. These color schemes remain harmonious regardless of their rotation on the color wheel as long as the colors are equally spaced from each other.

The color schemes may form any suitable color schemes including, but not limited to, monochromatic color schemes, analogous color schemes, complimentary color schemes, split complimentary color schemes, triadic color schemes and the like. Any suitable color or colors may be utilized in accordance with the color schemes.

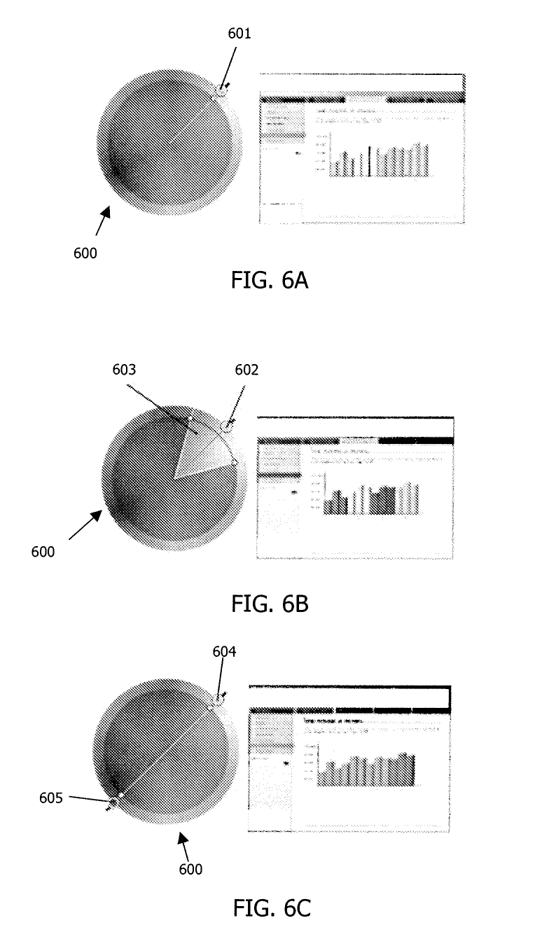

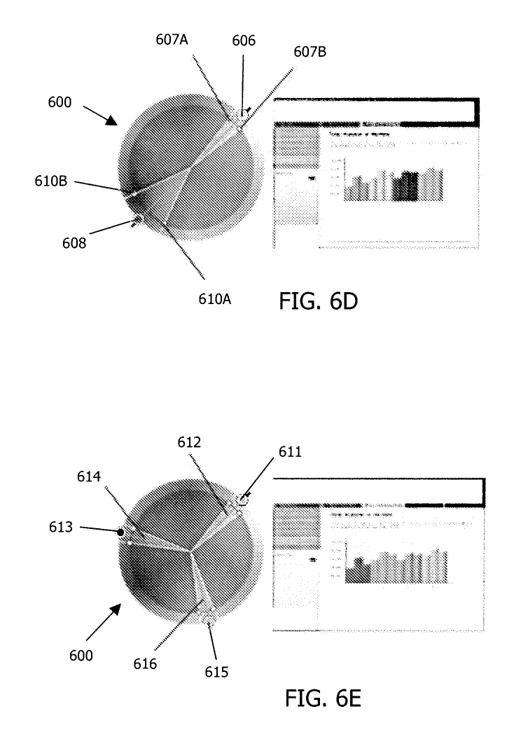

The monochromatic color scheme uses variations in lightness and saturation of a single color 601 on the color wheel 600 as shown in FIG. 6A. Any suitable color may be used in the monochromatic color scheme. The monochromatic colors produce a soothing effect and are easy on the eyes.

The analogous color scheme is similar to the monochromatic color scheme but offers more nuances. The analogous color scheme uses one color 602 as the primary or dominant color and then uses adjacent colors, such as those colors in, for example, range 603, to enrich the scheme as can be seen in FIG. 6B. The range 603 may be any suitable range, for example, that is narrower or broader than that shown in the figure.

The complimentary color scheme is high contrast and uses two colors 604, 605 that are opposite each other on the color wheel as shown in FIG. 6C. Although any suitable colors may be used in this color scheme the complimentary color scheme looks best when warm colors (e.g. red) are placed next to a cool color (e.g. aqua).

The split complimentary color scheme shown in FIG. 6D is a variation of the standard complimentary color scheme. The split complimentary color scheme uses two colors 606, 608 that are opposite each other on the color wheel 600. The split complimentary color scheme also uses two colors adjacent to each of the colors 606, 608. For example, the colors 610A, 610B adjacent to color 608 and the colors 607A, 607B adjacent to color 606 may be used. This scheme provides high contract without the strong tension of the complimentary scheme.

The triadic color scheme shown in FIG. 6E uses three dominant colors 611, 613, 615 that are equally spaced around the color wheel 600. Adjacent colors in the ranges 612, 614, 616 may also be used to enrich their corresponding dominant color 611, 613, 615. The ranges 612, 614, 616 may be any suitable ranges that are larger or smaller than those shown in the figure. This color scheme offers strong visual contrast while at the same time appearing harmonious and balanced.

Any suitable algorithms may be employed to automatically optimize the user interface in accordance with the color theory. The algorithms may include any suitable image processing techniques for accessing any suitable properties of the user interfaces. The image processing techniques may include, but are not limited to, image thresholding, edge detection, image filtering, histogram equalization, discrete Fourier transformation, fast Fourier transformation, Gaussian filtering, etc. The properties of the interface may include, but are not limited to, color distribution, edges, frequency of intensity, histograms, etc.

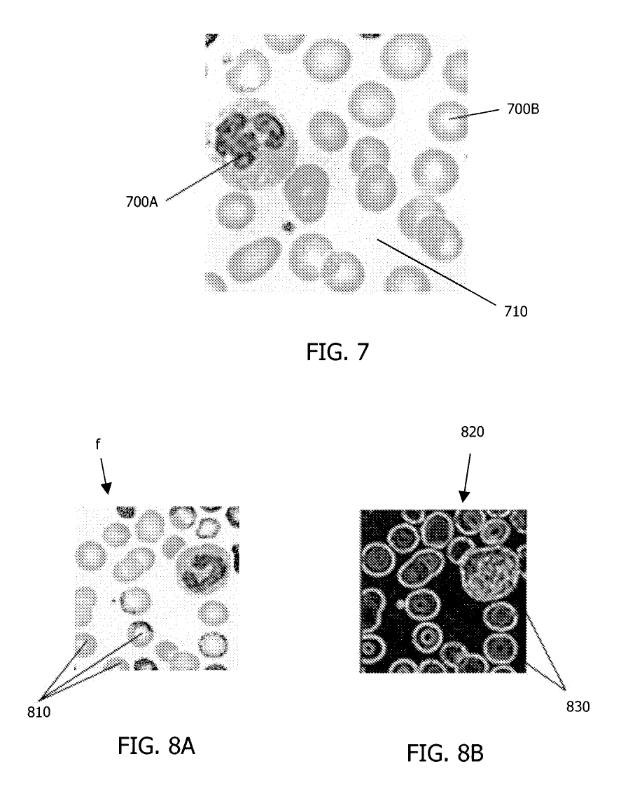

As can be seen in FIG. 7, a threshold may be selected to separate an object 700A, 700B from the background 710 of the image. A threshold value may be selected mathematically or subjectively to obtain a binary image as shown in FIG. 7. The binary or two-valued image obtained from image thresholding may allow for the separate optimization of the background 710 and the foreground objects 700A, 700B. In alternate embodiments, any suitable image processing may be used to separate the foreground form the background.

The edge detection process is employed to mark the points in a digital image at which the luminous intensity changes sharply such as, for example, at the edge of an object. Examples of edge detectors include, but are not limited to Laplacian, Prewitt, Sobel, Kirsch, vertical, horizontal, etc. Any suitable operator g may be used in the edge detection process. For example the operators may be based on the first or second derivative of the image intensity. The operator is convolved with an input image f as shown in FIG. 8A to obtain the operation (f*g) which would highlight all sharp transitions in luminous intensity. The operation (f*g) results in image 820. By thresholding this resulting image 820, the edges 830 of the objects 810 are extracted from the rest of the image information as shown in FIG. 8B. Edge detection may be utilized to detect the nature of the edges of objects presented to a user in a user interface so that the object may be optimized to match, for example, font characteristics. For example, softer edges may indicate a lighter theme with a font such as Comic Sans while harder edges may indicate a more serious theme with fonts such as Arial. In alternate embodiments, any suitable edge characteristic may be associated with any suitable style of theme.

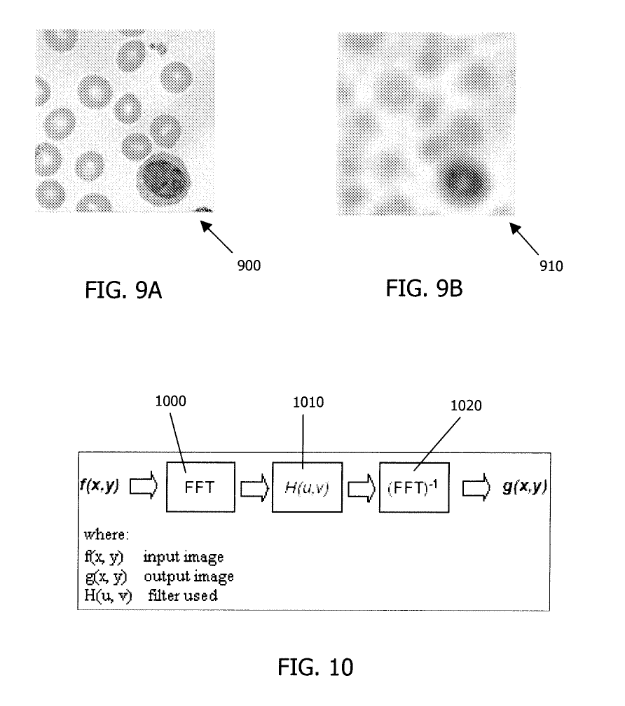

Referring now to FIGS. 9A, 9B and 10, the image filtering process will be described. Image filtering removes some frequencies from an image while leaving other frequencies intact. The cutoff frequency (ω_{c}) may be used to delineate between wanted frequencies and unwanted frequencies. The decision which frequencies are wanted or unwanted is subjective and is usually based on the application at hand. When the frequency content of an image is centered, all frequencies between zero and ω_{c} are referred to as the low-frequency content of the image. These low frequencies relate to smooth areas of the input image. The smooth areas of the image may have characteristics that do not vary or vary in small amounts. All frequencies equal to or greater than ω_{c} are the high-frequency content of the image. The high frequencies of the image may relate to abrupt or sharp changes or transitions such as, for example, edges. A low pass filter that retains the low frequencies in the image will blur or lessen sharp transitions depending on the value of ω_{c}. An example of an input image 900 and an output image 910 are shown in FIGS. 9A and 9B, where the output image has undergone a low-pass filtering. A high pass filter will discard the low frequency content of the image while retaining the high frequency content. The high pass filter will emphasize the sharp transitions while removing smooth or background information from the image. These same operations (emphasizing edges and smoothing) can also be performed in the spatial domain through edge detection and smoothing. However, the frequency domain allows for the use of fast Fourier transform and the various filters that can be applied (H(u,v)). FIG. 10 illustrates the image filtering steps. As can be seen in FIG. 10 an input image f(x,y) is operated on using fast Fourier transform 1000, filters 1010 and inverse fast Fourier transform 1020 to obtain the output image g(x,y).

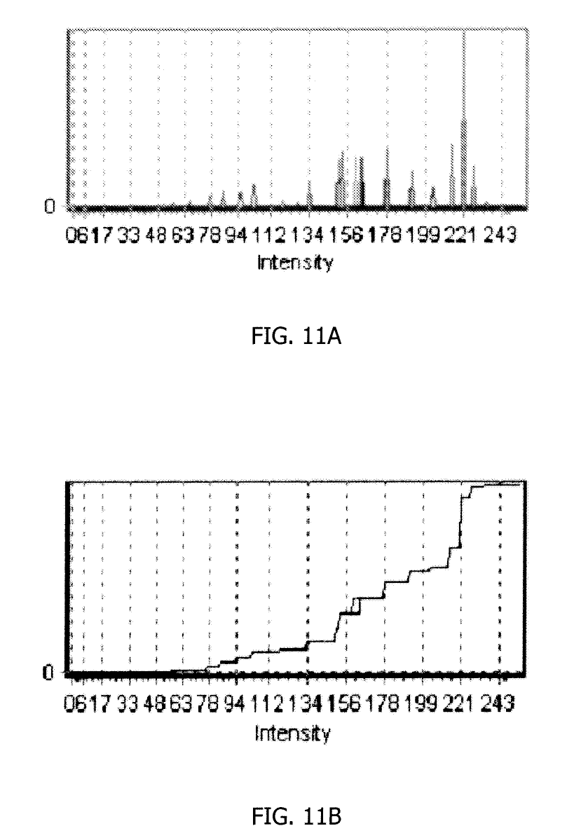

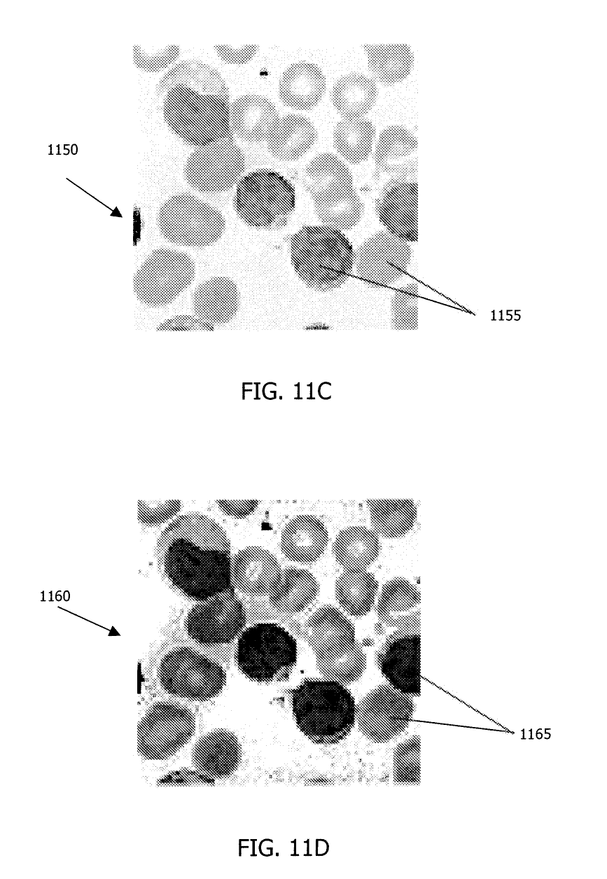

An image may also be enhanced through manipulation of the image histogram. The histogram is a two-dimensional graph where the horizontal axis represents the gray scale from zero (black) to 255 (white) assuming an 8-bit resolution for pixels (2⁸=256). The vertical axis of the histogram represents the frequency of an occurrence of a given gray scale through the entire image. An exemplary base density histogram can be seen in FIG. 11A and an exemplary base cumulative histogram can be seen in FIG. 11B. As a bar graph the histogram represents a frequency distribution in which the widths of the bars are proportional to the classes into which the variable has been divided and the heights of the bars are proportional to the class frequencies. Histogram equalization improves the contrast of the image by making the histogram more uniform. As can be seen in FIGS. 11C and 11D, the histogram of the input image 1150 has been equalized to produce an output image 1160 having higher contrast than the input image 1150. As can be seen in the Figures, the objects 1165 of the output image 1160 have better contrast than the object 1155 of the input image. Histogram equalization makes the histogram more uniform but does not flatten the histogram. The equalization redistributes the intensity distributions based on a statistical process. New intensities will not be introduced into the image as a result of the equalization because the histogram equalization is a point process. Existing values of the intensities will be mapped to new values while the number of intensities in the resulting image will be equal to or less than the number of intensities in the input image.

The discrete Fourier transform or finite Fourier transform may also be utilized to analyze the frequencies of an image or objects on a user interface. The discrete Fourier transform can be computed using a fast Fourier transform algorithm. It can be demonstrated through time or space dissemination (or breaking the dimension into powers of 2), that the Fourier transform of an N×N image can be computed through N 2×2 Fourier transforms. In mathematical terms, the computational load for an N×N image is reduced from N⁴ computations to N⁴ log₂ N⁴.

The Laplacian of a Gaussian Filter may also be used for image processing in accordance with the disclosed embodiments. The Laplacian operator is a second derivative-based edge detector. The function of the Laplacian operator is substantially similar to the edge detection process described above with respect to FIGS. 8A and 8B. The Laplacian operator is defined as

$${∇}^{2} = \frac{{\partial }^{2}}{\partial {x}^{2}} + \frac{{\partial }^{2}}{\partial {y}^{2}}$$

### Performing a second derivative on an input image f(x,y) in the spatial domain in both the x and y directions results in the following operation that extracts the edges from the image.

$$\begin{matrix}L ( x , y ) = {∇}^{2} f ( x , y ) \\ = \frac{{\partial }^{2} f ( x , y )}{\partial {x}^{2}} + \frac{{\partial }^{2} f ( x , y )}{\partial {y}^{2}}\end{matrix}$$

Since derivative filters are very sensitive to noise, any suitable filter may be used to soften edges, and to filter out spurious points in an image before applying the Laplacian. The Laplacian may be used in conjunction with the Gaussian function to obtain the Laplacian of a Gaussian operation. The two-dimensional form of the Gaussian function can be written as:

$$h ( x , y ) = {e}^{- \frac{{x}^{2} + {y}^{2}}{2 {σ}^{2}}}$$

where σ is the standard deviation. The Gaussian function smoothes or blurs images based on the standard deviation. When the Laplacian is performed after the Gaussian filter an image is output having edge detection of smoothed out images. When the Laplacian and Gaussian filters are combined, the Laplacian of Gaussian (LoG) operation (also known as the Marr-Hildreth operator) defines as:

$$LoG ( x , y ) = - \frac{1}{π {σ}^{4}} ( 1 - \frac{{x}^{2} + {y}^{2}}{2 {σ}^{2}} ) {e}^{\frac{{x}^{2} + {y}^{2}}{2 {σ}^{2}}}$$

Using the above described imaging processing techniques, the user interface of an electronic device may be dynamically modified when the components or items of the user interface change. The color schemes used in the modification of the user interface may correspond to the color wheel principles described above with respect of FIGS. 5A through 6C. However, in alternate embodiments, any suitable color schemes may be used in the dynamic modification of the user interface.

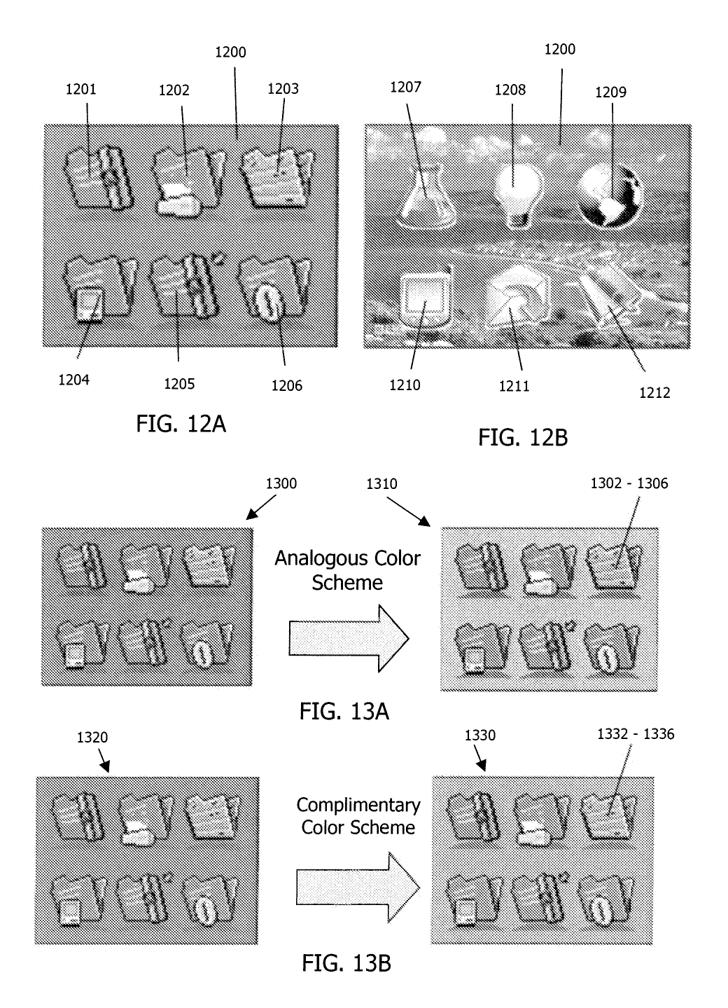

Referring to FIGS. 12A and 12B, user interfaces having backgrounds 1200 and foregrounds are shown where the foreground objects 1201-1212 have the same colors, similar colors or colors that clash with the background color. These interfaces 1200 may be the input interfaces in the dynamic modification process. When the colors of the foreground objects are similar to the background color, the foreground objects are difficult to recognize and blend in with the background. These user interfaces are less effective than user interfaces with color schemes in accordance with the color wheel principles described above.

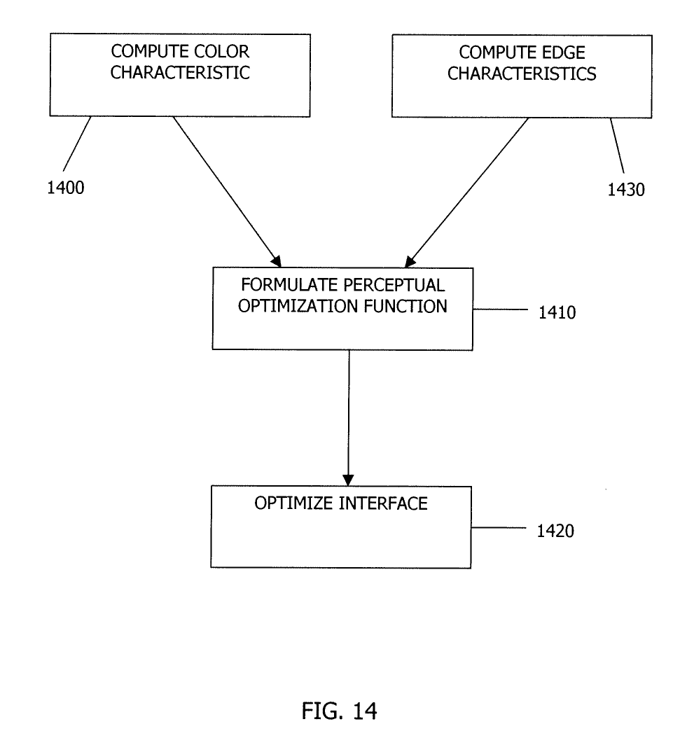

The color perception principles described herein may be used to automatically enhance the user interfaces shown in FIGS. 13A and 13B to improve the readability of the foreground objects. For example, any suitable software or hardware component, such as processor 201 of the electronic device may compute any suitable characteristics of any suitable part of the user interface. In this example, the dominant colors in the foreground of the user interface are computed (FIG. 14, Block 1400). Based on the determination the computed characteristics a perceptually based optimization function can be formulated (FIG. 14, Block 1410). The optimization function may use the computed characteristics, which in this example is the dominant color of the foreground, in conjunction with the color wheel principles to determine a suitable color for the background. The background may be perceptually optimized in any suitable manner (FIG. 14, Block 1420) such as by, for example, generating a new background, selecting a background from a database or a collection of imagery or the hue and saturation of the pre-existing background can be adjusted until the color scheme of the foreground and background are optimized in accordance with the optimization function. As can be seen in FIG. 13A, the input user interface 1300 is modified to produce an output user interface 1310 having a background 1301 with, for example, a color scheme that is an analogous to the colors of the foreground objects 1302-1306. FIG. 13B shows the input user interface 1320 is modified to produce an output user interface 1330 where the background 1331 has a color scheme that is complimentary to the colors of the foreground objects 1332-1336.

In alternate embodiments, the dominant colors in the background of the user interface may be computed and the perceptually based optimization function can be formulated according to the determination of the dominant background color. In this alternate embodiment, the foreground objects may be perceptually optimized in any suitable manner until the color scheme of the foreground and background are optimized in accordance with the optimization function.

The optimization of a user interface as described herein may also be applied to dynamic user interfaces where the content of the user interface is periodically or constantly updated. Examples of dynamic user interfaces include, but are not limited to, media browsers such as web browsers. Certain graphical properties of the images can be analyzed as the images are updated or in the case of video the first frame of a sequence of video frames can be analyzed. In alternate embodiments, any suitable number of video frames may be analyzed. The graphical properties may include, but are not limited to, color distribution, edges, texture, etc. A perceptually based optimization function can be created based on the analyzation of the images and/or video so that the user interface may be automatically modified to create aesthetically pleasing themes for the user interface background, font styles, etc. where the user interface is optimized for maximum perceptual clarity.

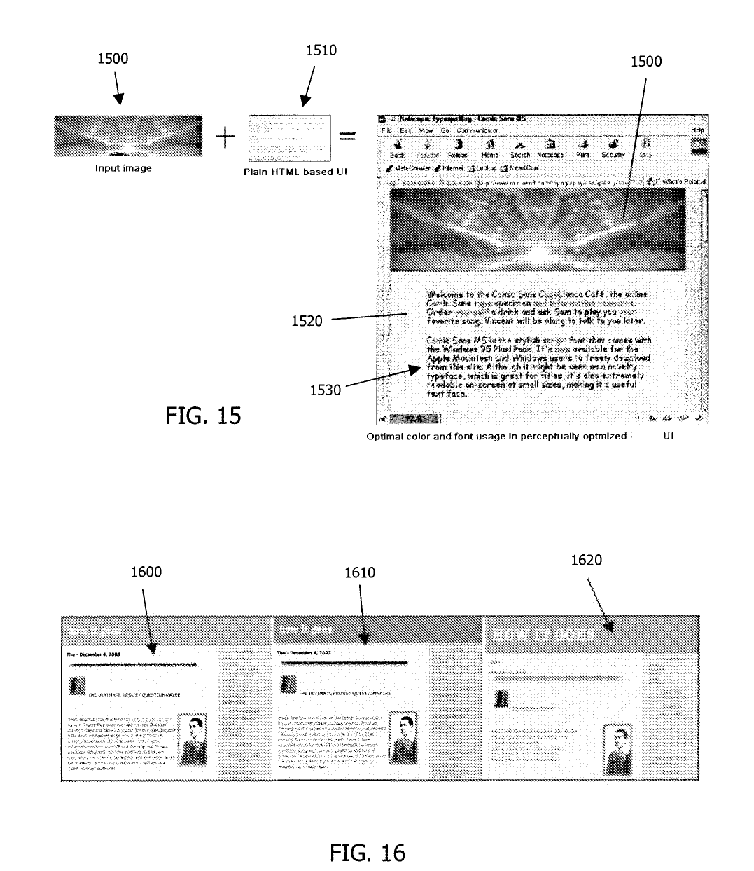

For example, referring to FIG. 15, a user interface including, for example, a web browser is shown. The images of the web browser may change any suitable number of times such as when for example the images on a web page are cycled or changed via the web page design and code or when the user changes web pages or goes to a different website. An image such as image 1500 may be included in a web page. This image may be associated with an HTML based web page 1510 that includes text. The dominant color of the image 1500 may be analyzed and a perceptually based optimization function may be created based on the analyzation of the image 1500. Any suitable color scheme may be assigned to the user interface in accordance with the optimization function. In this example a color scheme that is complimentary to the dominant color in the image 1500 is selected for the background 1520, font 1530, etc. of the user interface. In other embodiments, an analogous, monochromatic, split complimentary, triadic or any other suitable color scheme may be selected. In addition to determining the dominant color of the image, edge characteristics of the image may be computed (FIG. 14, Block 1430). The optimization function may account for the edge characteristics or a separate optimization function may be created for the edge characteristics. The font style of the user interface may be automatically selected based on the computed edge characteristics. In this example, softer font, such as Comic Sans is selected but in alternate embodiments any suitable font style may be selected.

The user interfaces described herein may provide a user with any number of suitable settings so that a user may specify preferences as to how the user interface is to be modified. These preferences may allow a user with special needs to customize the user interface. The special needs of a user may include, but are not limited to, color blindness, visual impairment, etc. For example, the user interface may have a settings menu where the user can select a preferred color scheme (e.g. analogous, complimentary, etc.), font style, font size, etc. The setting menu may also include a secondary preferences listing where the secondary preferences may be applied if it is determined that primary user preferences are not the most optimal settings for a particular user interface. In alternate embodiments, any suitable levels of preferences may be utilized for any number of suitable user interface characteristics. As can be seen in FIG. 16, a series of user interfaces are shown. The interface 1600 is the original user interface (e.g. the input image). The interface 1610 may be modified in accordance with user preferences to change red hues to for example yellow and blue hues to compensate for color blindness. The interface 1620 may be modified so that the font size is increased to compensate for a visual impairment. In alternate embodiments, the user interface may be modified in any suitable manner according to any suitable user preferences.

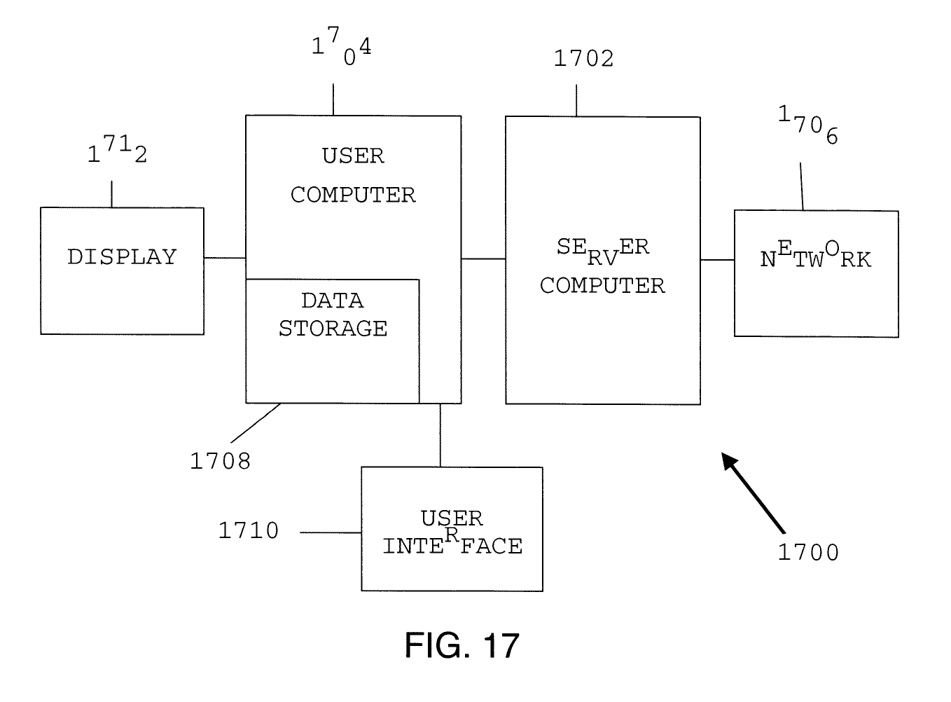

The disclosed embodiments may also include software and computer programs incorporating the process steps and instructions described above that are executed in different computers. FIG. 17 is a block diagram of one embodiment of a typical apparatus 1700 incorporating features that may be used to practice aspects of the invention. As shown, a computer system 1702 may be linked to another computer system 1704, such that the computers 1702 and 1704 are capable of sending information to each other and receiving information from each other. In one embodiment, computer system 1702 could include a server computer adapted to communicate with a network 1706. Computer systems 1702 and 1704 can be linked together in any conventional manner including, for example, a modem, hard wire connection, or fiber optic link. Generally, information can be made available to both computer systems 1702 and 1704 using a communication protocol typically sent over a communication channel or through a dial-up connection on ISDN line. Computers 1702 and 1704 are generally adapted to utilize program storage devices embodying machine readable program source code which is adapted to cause the computers 1702 and 1704 to perform the method steps disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1702 and 1704 may also include a microprocessor for executing stored programs. Computer 1702 may include a data storage device 1708 on its program storage device for the storage of information and data. The computer program or software incorporating the processes and method steps incorporating aspects of the invention may be stored in one or more computers 1702 and 1704 on an otherwise conventional program storage device. In one embodiment, computers 1702 and 1704 may include a user interface 1710, and a display interface 1712 from which aspects of the invention can be accessed. The user interface 1710 and the display interface 1712 can be adapted to allow the input of queries and commands to the system, as well as present the results of the commands and queries.

The user interfaces and applications described herein incorporate human perceptual principles while using the color distribution and font characteristics, if any, of the user interface to decide the optimal presentation characteristics of the user interface. The color and font characteristics of the user interface are automatically and dynamically manipulated based on the different heuristics of the user interface to improve the readability and clarity of items within the user interface rather than focussing on modifying the presentation or interaction with the physical environment.

These user interfaces may be employed in enterprise content adaptation services that adapt their contents to various types of graphics and/or user interface enabled terminals such as wearable devices, PDAs, automobile PCs and the like. The different terminal may have different capabilities with respect to their processing units, user interaction and communication. Applications in accordance with the disclosed embodiments that are run on these terminals may dynamically adapt their contents to each type f device when they are activated or run. These applications, which may be authored once, can be optimally targeted to various devices by enhancing the perceptual clarity and readability without re-authoring the content for each device.

The user interfaces may also be employed in any suitable browser applications, such as for example, mobile or desktop web browsers. The user interfaces may allow a device to present an intelligent user interface that caters to the user. For example, the interface may adapt for color blindness, sight impairment and high contrast environments. Aspects of the disclosed embodiments may also use perceptual principles to dynamically alter the look and feel of user interfaces based on preferences.

The embodiments described herein may provide a user interface developer with a tool so that content of a user interface can be authored just once and dynamically changed or updated if new media such as images or video are added or modified and/or is the user's needs change (e.g. degradation in vision, etc.). The embodiments described herein also minimize bad user interface design and adapts user interfaces for specific visual needs by automatically optimizing the usage of color and font based on perceptual principles

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. An apparatus comprising:
a display; and
a processor connected to the display, the processor configured to automatically modify an input user interface according to a perceptual optimization function and to cause an output user interface to be presented on the display.

2. The apparatus of claim 1, wherein the processor is configured to modify the output user interface according to predefined color schemes.

3. The apparatus of claim 2, wherein the color schemes include harmonious color combinations.

4. The apparatus of claim 2, wherein the color schemes include monochromatic color schemes, analogous color schemes, complimentary color schemes, split complimentary color schemes and triadic color schemes.

5. The apparatus of claim 1, wherein the processor is configured to modify the input user interface in accordance with predefined processing techniques.

6. The apparatus of claim 5, wherein the processing techniques include image thresholding, edge detection, image filtering, histogram equalization and discrete Fourier transformation, fast Fourier transformation and Laplacian of a Gaussian filter.

7. The apparatus of claim 1, wherein the processor is configured to modify the colors and font styles of the input user interface to maximize readability.

8. The apparatus of claim 1, wherein the processor is configured to determine a dominant color of at least one foreground object and modify the user interface with a color scheme in accordance with the dominant color.

9. The apparatus of claim 1, wherein the processor is configured to determine a dominant color of at least one foreground object and modify the user interface with a color scheme in accordance with the dominant foreground color.

10. The apparatus of claim 1, wherein the processor is configured to determine a dominant color of at least one background object and modify the user interface with a color scheme in accordance with the dominant background color.

11. The apparatus of claim 1, wherein the processor is configured to determine an edge characteristic of the user interface and modify a font style of the user interface in accordance with the edge characteristics.

12. The apparatus of claim 1, where the processor is configured to modify the user interface in accordance with the needs of a user.

13. A method comprising:
determining a dominant color of an input user interface;
formulating a perceptual optimization function; and
automatically modifying the input user interface according to the perceptual optimization function and causing an output user interface to be presented on the display.

14. The method of claim 13, wherein the input user interface is modified according to predefined color schemes.

15. The method of claim 14, wherein the color schemes include harmonious color combinations.

16. The apparatus of claim 15, wherein the color schemes include monochromatic color schemes, analogous color schemes, complimentary color schemes, split complimentary color schemes and triadic color schemes.

17. The method of claim 13, wherein the input user interface is modified in accordance with predefined processing techniques.

18. The method of claim 17, wherein the processing techniques include image thresholding, edge detection, image filtering, histogram equalization and discrete Fourier transformation, fast Fourier transformation and Laplacian of a Gaussian filter.

19. The method of claim 13, wherein the output user interface includes colors and font styles that maximize readability.

20. The method of claim 13, wherein the processor is configured to determine a dominant color of at least one foreground object and modify the user interface with a color scheme in accordance with the dominant color.

21. The method of claim 13, wherein modifying the input user interface comprises determining a dominant color of at least one foreground object and modifying the input user interface with a color scheme in accordance with the dominant foreground color.

22. The method of claim 13, wherein modifying the input user interface comprises determining a dominant color of at least one background object and modifying the input user interface with a color scheme in accordance with the dominant background color.

23. The method of claim 13, wherein the input user interface is modified in accordance with the needs of a user.

24. The method of claim 13, further comprising:
determining edge characteristics of the input user interface; and
automatically modifying the user interface in accordance with the perceptual optimization function, wherein the perceptual optimization function incorporates the dominant color and edge characteristics.

25. The method of claim 24, wherein a font style of the user interface is modified in accordance with the edge characteristics.

26. A computer program product comprising:
a computer useable medium having computer readable code means embodied therein for causing a computer to automatically modify a user interface, the computer readable code means in the computer program product comprising:
computer readable code means for causing a computer to automatically modify a user interface according to a perceptual optimization function and to cause an output user interface to be presented on a display.

27. The computer program product of claim 26, wherein the colors and font styles of the user interface are modified in accordance with the perceptual optimization function to maximize readability.
